(19) United States
(12) Patent Application Publication
(10) Pub. No.: US 2016/0295052 A1
(43) Pub. Date: Oct. 6, 2016

(54) IMAGE PROCESSING DEVICE AND IMAGE PROCESSING SYSTEM

(71) Applicant: KYOCERA Document Solutions Inc., Osaka (JP)

(72) Inventor: Kozo Tao, Osaka (JP)

(73) Assignee: KYOCERA Document Solutions Inc., Osaka (JP)

(21) Appl. No.: 15/035,414

(22) PCT Filed: Nov. 17, 2014
(86) PCT No.: PCT/JP2014/080351

§ 371 Date: May 9, 2016

(30) Foreign Application Priority Data
Nov. 27, 2013 (JP) 2013-245067

(51) Int. Cl. H04N 1/00; H04N 1/21

(52) U.S. Cl. CPC H04N 1/00859; H04N 1/00411; H04N 1/2179; H04N 1/00854; H04N 1/00477; H04N 2201/0094

(57) ABSTRACT

In an image processing device and an image processing system according to the present invention, a storage unit holds image processing jobs received by a job receiving unit. An authority information acquiring unit acquires authority information indicating authority that a user specified by a user specifying unit has with respect to the image processing job in the storage unit. Based on the authority information acquired by the authority information acquiring unit, a processable job extracting unit extracts an image processing job for which the user specified by the user specifying unit has authority to delete or execute from among the image processing jobs in the storage unit. A display unit displays the image processing job extracted by the processable job extraction unit.

### TECHNICAL FIELD

The present invention relates to image processing devices and image processing systems, those having storage areas to hold image processing jobs.

### BACKGROUND ART

Recently, MFPs (multi-function peripherals) including functions of scanners, facsimile machines, printers, and copying machines are used in offices. For instance, the MFP is often used in a situation of connecting with information processing terminals like personal computers through network like LAN (Local Area Network). The MFP functions as an image forming device to print on papers image data inputted from the information processing terminal, functions as an image reading device to acquire image data to be used by the information processing terminal, and functions as a document management device to store document image data as searchable data.

To the MFP, a plurality of users input various image processing jobs such as a print job, a data transmission job, an image reading job, and so on. When the inputted image processing job cannot be executed immediately, or when the job needs not to be executed immediately, the image processing job is stored in a storage area of the MFP, like HDD (Hard Disk Drive), and waits until the job is executed. However, it is hard for the MFP to ensure the storage area storing the image processing jobs without limit. Therefore, there is a possibility that the memory area cannot store the image processing job any more (namely, a memory full state), and the input of the image processing job to the MFP is suspended. In order to settle such trouble when the memory full state occurs, many kinds of techniques are suggested (see Patent Documents 1 to 4, for example).

Patent Document 1 discloses a technique employed by the image forming device that continuously reads plural sheets of originals by the image reading unit to store the read image data one by one in a non-volatile memory. In this case, the image forming device suspends the reading when the memory full state occurs in the non-volatile memory, and lets the user specify an image data to be deleted from the stored image data in the non-volatile memory.

Patent Document 2 discloses a technique employed by the image forming device that has the storage unit storing the print job. In this case, the image forming device forcedly resumes at least one job of the print jobs stored in the storage unit when the memory full state occurs in the storage unit.

Patent Document 3 discloses a technique employed by the printing device that has an external memory having a specific capacity and storing the printing jobs. In this case, a status information, indicating whether or not the printing device can hold the print data, is acquired in a confidential printing mode. When the printing device can hold the print data, a secure information and the print data are transmitted to the printing device. When the printing device cannot hold the print data, the secure information is transmitted to the printing device first of all, and the print data is transmitted after the authentication by the printing device based on the secure information.

Patent Document 4 discloses a configuration to confirm a remained capacity of the memory at storing the image data in the memory, to stop the reading operation before the memory becomes the memory full state, and to stand by the reading operation till the remained memory capacity increases. In this case, when the remained memory capacity does not increase, the image data are stored in the memory till the memory becomes the memory full state. When the memory becomes the memory full state, a cause of the memory full state (an error cancel request for the job causing the error) is informed to an operator.

### RELATED ART DOCUMENTS

### Patent Documents

Patent document 1: Japanese Unexamined Patent Application Publication No. 2006-197467;

Patent document 2: Japanese Unexamined Patent Application Publication No. 2007-245703;

Patent document 3: Japanese Unexamined Patent Application Publication No. 2013-008155; and

Patent document 4: Japanese Unexamined Patent Application Publication No. 2003-087538.

### SUMMARY OF THE INVENTION

### Problems to be Solved by the Invention

In case of the techniques disclosed in the patent documents 1 and 2, the user can eliminate the memory full state by deleting or forcedly executing the previously stored image processing jobs. But under such configuration, the user can delete or execute the stored image processing jobs freely. That is to say, in this case, when the memory full state occurs, even if the user operating the MFP is not identical with the user that inputted the previously stored image processing job in the storage area, it is possible to delete or execute the image processing job. Therefore, for instance, even when the operating user makes the MFP read a mass of originals to store them in the storage area as the data transmission job and it causes the memory full state, the operating user can voluntarily execute the image processing job inputted by the other user. Such situation is not desirable in view of the security issue.

According to the configuration disclosed in Patent Document 3, it is possible to have an effect when the confidential print is inputted. However, the disclosed technique is not considered to be applied to the other image forming jobs, namely, it is difficult to apply the disclosed technique to the input of the data transmission job or the image reading job, for example.

In addition, the configuration in Patent Document 4 does not disclose an effective countermeasure where the cause of the memory full state is an accumulation of the unexecuted image processing jobs.

In view of the above problems in the conventional arts, the present invention has an object to provide the image processing device and image processing system that can eliminate the memory full state without breaking the security even if the memory full state occurs, and to improve the user friendliness with respect to the image processing jobs stored in advance.

### Means to Solving the Problems

In order to achieve the abovementioned object, the present invention employs following technical means. Specifically, the image processing device according to the embodiment of the present invention includes a job receiving unit, a storage unit, a user specifying unit, an authority information acquiring unit, a processable job extracting unit, and a display unit. The job receiving unit receives an image processing job. The storage unit holds the image processing job received by the job receiving unit. The user specifying unit specifies a user currently operating. The authority information acquiring unit acquires authority information indicating authority that the user specified by the user specifying unit has with respect to the image processing job held in the storage unit. The processable job extracting unit extracts the image processing job from the image processing jobs in the storage unit, the image processing job for which the user specified by the your specifying unit has the authority of deletion or execution, based on the authority information obtained by the authority information acquiring unit. The display unit displays the image processing job extracted by the processable job extracting unit.

### BRIEF DESCRIPTION OF THE DRAWINGS

FIG. 1 is a schematic configuration diagram showing a general arrangement of a MFP according to an embodiment of the present invention;

FIG. 2 is a pattern diagram showing an operation panel of the MFP according to the embodiment of the present invention;

FIG. 3 is diagram showing a hardware structure of the MFP according to the embodiment of the present invention;

FIG. 4 is a functional block diagram showing the MFP according to the embodiment of the present invention;

FIG. 5 is a flowchart indicating a memory full state eliminating procedure executed by the MFP according to the embodiment of the present invention;

FIG. 6 is a diagram showing a processable job list displayed by the MFP according to the embodiment of the present invention; and

FIG. 7 is a diagram showing a list of jobs under requesting displayed by the MFP according to the embodiment of the present invention.

### MODE FOR CARRYING OUT THE INVENTION

The embodiment of the present invention will be explained in detail with reference to the attached drawings. The present invention is materialized by a digital MFP.

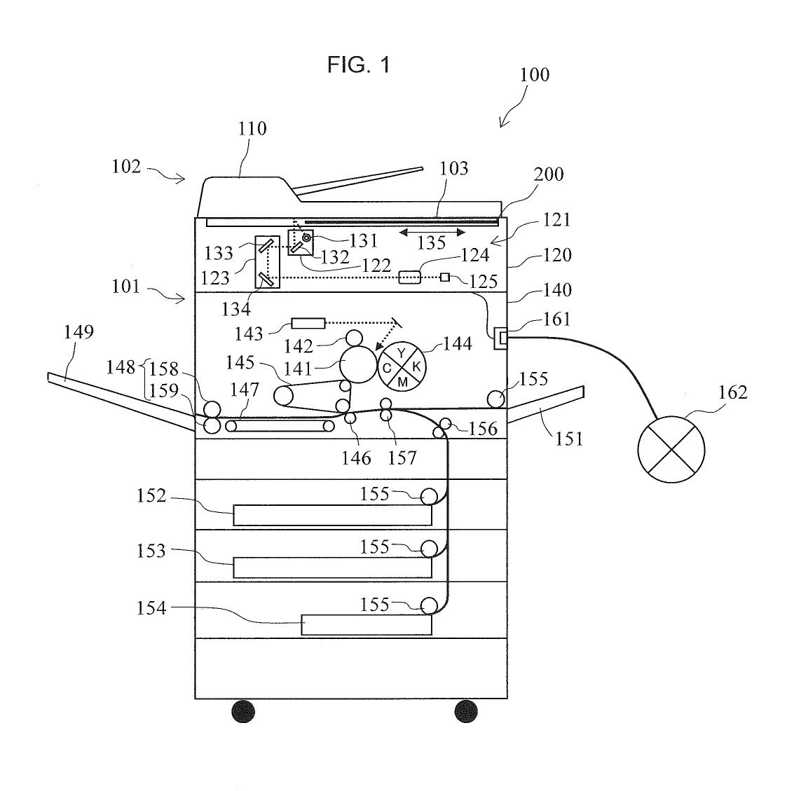

FIG. 1 is a schematic configuration diagram showing a general arrangement of the MFP according to an embodiment of the present invention. As shown in FIG. 1, the MFP 100 includes a body 101 having an image reading unit 120 and an image forming unit 140, and a platen cover 102 provided on the body 101. An original plate 103, which is made of a transparent plate like a contact glass, is provided on a top surface of the body 101. The original plate 103 is opened and closed by the platen cover 102. The platen cover 102 is provided with a document feeder 110. An operation panel 200 is provided on a front surface of the MFP 100.

The image reading unit 120 is provided under the original plate 103. The image reading unit 120 reads an image of an original by a scanning optical system 121, and creates digital data of the image (image data). The original can be placed on the original plate 103 or the document feeder 110. The scanning optical system 121 includes a first carriage 122, a second carriage 123, and a condenser lens 124. The first carriage 122 is provided with a linear light source 131 and a mirror 132, and the second carriage 123 is provided with mirrors 133 and 134. The light source 131 illuminates the original. The mirrors 132, 133 and 134 guide the light reflected from the original to the condenser lens 124, and the condenser lens 124 forms a light image on a light receiving surface of a line image sensor 125.

In the scanning optical system 121, the first carriage 122 and the second carriage 123 are provided so as to reciprocate in a sub-scanning direction 135. The image sensor 125 can read the image of the original placed on the original plate 103 by moving the first carriage 122 and the second carriage 123 in the sub-scanning direction 135. In case of reading the image of the original placed on the document feeder 110, the image reading unit 120 temporarily stops the first carriage 122 and the second carriage 123 so as to correspond to an image reading position, and then reads the image of the original passing through the image reading position by the image sensor 125. The image sensor 125 creates the image data of the original corresponding to each color component, for example, R (red), G (green), and B (blue), from the light image incident on the light receiving surface.

The created image data can be printed out on a paper by the image forming unit 140. The created image data also can be transmitted to other devices (not shown) from a network interface 161 via a network 162.

The image forming unit 140 prints on the paper the image data obtained by the image reading unit 120 and the image data received from the other device through a network 162. The image forming unit 140 is provided with a photosensitive drum 141. The photosensitive drum 141 rotates at a fixed speed in one direction. Around the photosensitive drum 141, a charging unit 142, an exposing unit 143, a developing unit 144, and an intermediate transfer belt 145 are provided in order from an upstream side of the rotational direction. The charging unit 142 uniformly electrifies a surface of the photosensitive drum 141. The exposing unit 143 irradiates the surface of the uniformly electrified photosensitive drum 141 with the light beam corresponding to the image data, and then forms an electric latent image on the photosensitive drum 141. The developing unit 144 sticks the toner to the electric latent image, and forms a toner image on the photosensitive drum 141. The intermediate transfer belt 145 transfers the toner image on the photosensitive drum 141 to the paper. When the image data is a color image, the intermediate transfer belt 145 transfers each color toner image on a same paper. Besides, the color image in RGB form is respectively converted to color images in C (Cyan), M (Magenta), Y (Yellow), and K (Black) forms, and then the image data in respective colors is inputted to the exposing unit 143.

The image forming unit 140 feeds a paper from a manual paper feed tray 151 or paper feeding cassettes 152, 153, and 154 to a transfer portion between the intermediate transfer belt 145 and a transfer roller 146. The various size of papers can be placed on or accommodated in the manual paper feed tray 151 and the paper feeding cassettes 152, 153, and 154. The image forming unit 140 selects the paper specified by a user, or the paper detected automatically corresponding to a size of original, and then feeds the selected paper from the manual paper feed tray 151 or the paper feeding cassette 152, 153 or 154 by a feeding roller 155. The fed paper is conveyed to the transfer portion by a conveyance roller 156 and a resist roller 157. The paper on which the toner image is transferred is conveyed to a fixing unit 148. The fixing unit 148 has a fixing roller 158 including a heater and a pressure roller 159, and the toner image is fixed on the paper by the heat and the pressure. The image forming unit 140 ejects the paper passing through the fixing unit 148 to a copy receiving tray 149.

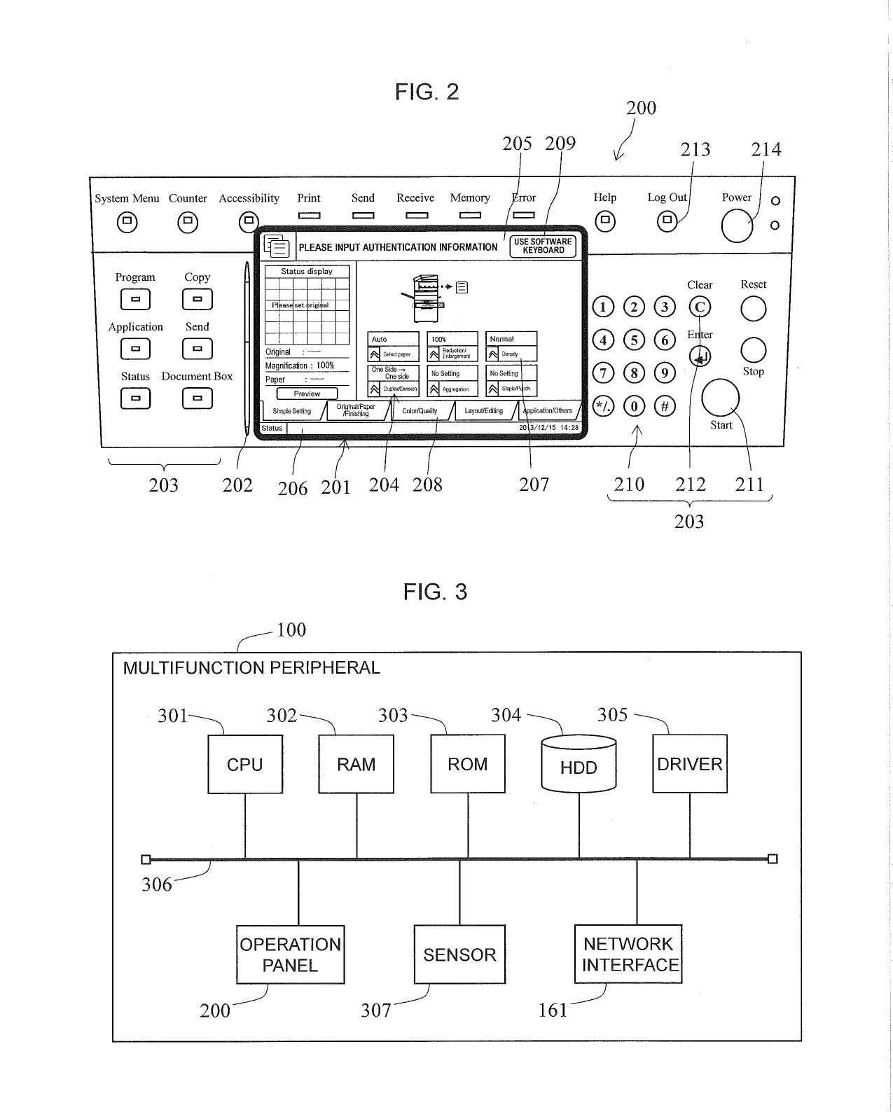

FIG. 2 is a view showing an appearance of the operation panel provided to the MFP. The user can give an instruction of the copy start or the other instructions to the MFP, or confirm the status and setting of the MFP 100, by means of an operation panel 200. The operation panel 200 includes a display 201 with a touch panel, and operation keys 203. The display 201 is provided with a screen of a liquid display displaying operation buttons and messages, and a sensor to detect a portion pressed on the screen. A method of detecting the pressed position is not limited in particular, and it may employ any method of the Resistive Film method, the Electrostatic Capacity method, the Surface Acoustic Wave method, or the Electromagnetic Wave method, and so on. The user can input from the display 201 using his finger or a touch pen 202.

The display 201 displays an operation screen having a button displaying section 204, a message displaying section 205, and a status displaying section 206. The button displaying section 204 has a plurality of tabs 208, and each tab includes operation buttons corresponding to the processing categorized as each tab. A “simple setting” tab has the operation buttons to be used for a basic setting. As shown in FIG. 2, the operation buttons are for setting a paper size, a copy magnification ratio, the density, a print surface of paper, a page aggregation, and a post processing. For instance, when the user presses a “density” button 207, a pop-up screen including buttons to select the printing density, such as “light”, “normal” and “dark”, is displayed superimposing on the operation button, the density is determined by the selection (press down) of the user. The button displaying section 204 shown in FIG. 2, in addition to the “simple setting” tab, includes the other tabs, such as an “original/paper/finishing” tab, a “color/quality” tab, a “layout/editing” tab, and an “application/others” tab. When the user operates to select one tab from the tab buttons 208, the display changes the screen corresponding to the selected tab. During the tab is being selected, the other tabs and other elements are hidden on the operation screen.

The message displaying section 205 displays a message notifying the user of the setting, such as the copyable or not, a number of duplicates, and so on. Besides, the MFP 100 according to the embodiment of the present invention is configured to execute a user authentication (log-in processing) in order to confirm a use qualification of the user (the operator), when the user uses the MFP 100. FIG. 2 shows a state before the user authentication is executed, and the message displaying section 205 displays a message that requests an input of the user authentication information, such as “Please input authentication information”. In this case, the software keyboard is displayed on the display 201 when the user selects (presses) a software keyboard display button 209, whereby the user inputs the user authentication information.

The status displaying section 206 displays status information of the device if necessary. The display of the status displaying section 206 reflects results detected by respective sensors provided to the MFP 100. The device status information means a message to warn the user about the abnormality of the device even though the device is operable. The information, for example, includes messages: the residual amount of papers is little; the original plate 103 is dirty; and, the facsimile document was stored in a memory when the received facsimile document is set to be stored in the memory. The device status information also may include the occurrence of paper exhaustion, the conveyance jamming, and so on.

The operation keys 203 includes numeric keys 210, a start key 211, a clear key 212, Log-out key 213, and a main power supply key 214. The numeric keys 210 are used for setting the number of duplicates and the ratio of copy magnification ration. After the user has completed such setting, the MFP 100 displays “copyable (setup done)” on the message displaying section 205, for example, and the user is notified that the user that the setup was done by the user. The start key 211 is used to instruct the start of copy and image print. When the user wishes to cancel the setting made by himself, he operates the clear key 212. Since the user can know whether or not the machine has accepted the user setting based on the above-mentioned message, the user may operate only the clear key 212 when the user setting is unnecessary. The main power supply key 214 is used to switch ON and OFF of the MFP 100. According to the embodiment of the present invention, it is configured that, except for the input of the authentication information, the operation from the operation panel 200 is prohibited till the use qualification of the user has been confirmed by the user authentication. When the authenticated user press the log-out key 213, or when the operation of the operation panel 200 and the operation of the image forming unit 140 are not done for a specific time after the authentication, the MFP 100 is configured to return to the state before the authentication is executed.

FIG. 3 is a view showing a hardware configuration of a control system of the MFP. In the MFP 100 according to the embodiment of the present invention, a CPU (Central Processing Unit) 301, a RAM (Random Access Memory) 302, a ROM (Read Only Memory) 303, a HDD (Hard Disk Drive) 304, and a driver 305 corresponding to driving units of the document feeder 110, the image reading unit 120, and the image forming unit 140, are connected via an internal path 306. The ROM 303 and the HDD 304 store programs, and the CPU 301 controls the MFP 100 according to instructions from the control programs. For instance, the CPU 301 uses the RAM 302 as a working area, and sends and receives the instruction and the data from and to the driver 305, so that the CPU 301 can control the working of each driving unit. The HDD 304 is also used to store the image data obtained from the image reading unit 120 and the image data received from the outside devise via network interface 161.

The internal path 306 is also connected with the operation panel 200, the network interface 161, and various sensors 307. The operation panel 200 receives the user operation, and supplies a signal based on the operation to the CPU 301. The operation panel 200 displays an operation screen on a display 201 provided to the operation panel 200 based on the control signal from the CPU 301. The sensor 307 includes various kinds of sensors, such as an open and shut detecting sensor to detect the opening and the shutting of the platen cover 102, an original detecting sensor to detect an original on the original plate 103, a temperature detecting sensor to detect the temperature of the fixing unit 148, a paper detecting sensor to detect the paper or the original to be conveyed, and so on.

The CPU 301 executes the programs stored in the ROM 303, whereby following means (functional blocks) can be realized, and it is possible to control the working of each means based on the signals from these sensors.

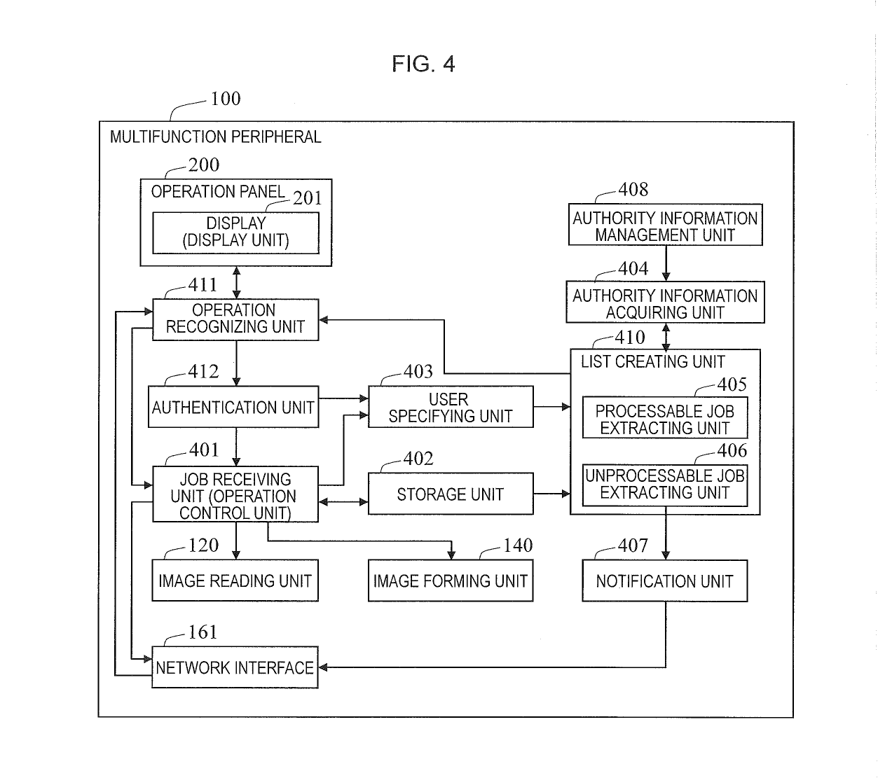

FIG. 4 is a functional block diagraph of the MFP according to the embodiment of the present invention. As shown in FIG. 4, the MFP 100 according to the embodiment of the present invention includes a job receiving unit 401, a storage unit 402, a user specifying unit 403, an authority information acquiring unit 404, and a processable job extracting unit 405.

The job receiving unit 401 receives image processing jobs. The image processing jobs includes any kinds of jobs to be stored in the storage unit 402, for example, a print job, a facsimile transmission job, a data transmission job, an image reading job, and etc. In addition to the image processing jobs created by the user operation of the MFP from the operation panel, the image processing jobs includes various image processing jobs inputted from the other devices like the information processing terminals through the network interface 161.

According to the embodiment of the present invention, the operation inputted from the display 201 is detected by a sensor to detect a pressed position on the display 201. Coordinates of the pressed position detected by the sensor is acquired by an operation recognizing unit 411. The operation recognizing unit 411 holds the coordinates of screen elements like buttons constituting the operation screen displayed on the display 201. The operation recognizing unit 411 recognizes a content of the user operation based on the held coordinates information and the detected pressed position coordinates. The operation recognizing unit 411 also recognizes the pressing of the operation key 203 on the operation panel 200.

Moreover, the operation recognizing unit 411 recognizes the operations inputted through the network interface 161. For instance, when the print job is inputted through the network interface 161, the operation recognizing unit 411 recognizes operation information included in the print job (“print”, in this case) and a user authentication information to be used to the user authentication based on the inputted print job.

As described above, the MFP 100 is configured to prohibit the operation from the operation panel 200 till the use qualification of the user can be confirmed by the user authentication, except for the input of the information with respect to the authentication. The user authentication is executed by an authentication unit 412.

The authentication unit 412 determines whether or not the user authentication information inputted from the operation panel 200 satisfies authentication conditions registered in advance, whereby the user authentication is executed. Here, the user inputs the user authentication information by means of the software keyboard displayed on the display 201, as described above. When the image processing job is inputted through the network interface 161, the inputted image processing job includes the user authentication information.

The MFP 100 uses a user ID uniquely allocated to each user and a password associated with the user ID as the user authentication information. The user ID may be information capable to specify the user, and the user ID consists of information using characters and symbols inputted from the software keyboard in this embodiment.

According to the embodiment of the present invention, the authentication unit 412 has stored an authorized user list recording the user IDs of the users authorized to use the MFP 100 and the password associated with the user ID. When the user ID and the password recognized by the operation recognizing unit 411 are included in the authorized user list, the authentication unit 412 determines that the user satisfy the user authentication condition. When the user authentication condition was satisfied, the authentication unit 412 authorizes the user to use the MFP 100 (to create the image data by the image reading unit 120; to print the image data by the image forming unit; and to transmit the image data via network interface 161). When the user authentication condition is not satisfied, the authentication unit 412 prohibits the user to use the MFP 100. Besides, the job receiving unit 401 according to the embodiment of the present invention also functions as an operation control unit to execute various processing of the MFP 100, such as creating the image data by the image reading unit 120, printing the image data by the image forming unit 140, and so on based on the operation recognized by the operation recognizing unit 411. The authentication unit 412 materializes the various kinds of processing by cancelling the working limitation of the job receiving unit 401.

The storage unit 402 holds the image processing jobs received by the job receiving unit 401. According to the embodiment of the present invention, the image processing jobs created by the MFP 100 and the image processing jobs inputted from the other devices through the network interface 161 are generally stored in the storage unit 402. For instance, when the user operates the MFP 100 to executes the printing of the image data read by the image reading unit 120 in a mode of the aggregation printing, the booklet printing, or the printing of plural duplicates, the created image data by the image reading unit 120 is necessary to be stored in a memory temporally. Therefore, such image processing is also stored in the storage unit 402 as the image processing job (the print job).

On the other hand, in case of the interruption printing when the image data created by the image reading unit 120 is printed one after another without storing the created data, the created image data is held on the RAM 302, for example, and then inputted to the image forming unit 140 one after another. Therefore, the image processing job (the print job) is not stored in the storage unit 402. It is not limited in particular, according to the embodiment of the present invention, the HDD 304 functions as the storage unit 402. Besides, it is configured, according to the embodiment of the present invention, that the image processing job is stored in the storage unit 402 being associated with the information (the user ID) to specify the user that created (or inputted) the image processing job.

The user specifying unit 403 specifies the operating user. The operating user is a user that is operating the MFP 100 to create the image processing job by means of the operation panel, for example. Otherwise, the operating user may be also a user that is inputting the image processing job through the network interface 161. According to the embodiment of the present invention, when the storage unit 402 becomes the memory full state and the creation or input of the image processing job is suspended in the middle of creating the image processing job in the MFP 100 or inputting the image processing job created by the other device to the MFP 100, the user specifying unit 403 specifies the operating user that is creating or inputting the image processing job. In this case, the memory full state is a state that the storage unit cannot store the image processing jobs any more. It is not limited in particular, but the user specifying unit 403 specifies the operating user based on the user authentication information used to the user authentication by the authentication unit 412.

The authority information acquiring unit 404 acquires authority information indicating authority that the user specified by the user specifying unit 403 has with respect to the image processing job in the storage unit 402. The authority information is associated with respective users listed in the authorized user list. The authority information to be set to respective users may be any authorities such as “only the image processing job created by the user himself can be executed or deleted” or “only the image processing job created by a member of the user's group can be executed or deleted”. It is not limited in particular, according to the embodiment of the present invention, that the authority information management unit 408 has previously stored an authority information list recording the user ID of the user in the authorized user list and the authority information associated with the user ID.

In the example shown in FIG. 4, the information (the user ID) of the user specified by the user specifying unit 403 is inputted to the authority information acquiring unit 404 through a list creating unit 410. The authority information acquiring unit 404 acquires the authority information associated with the inputted user information from the authority information list in the authority information management unit 408, and then inputs the authority information to the list creating unit 410.

The processable job extracting unit 405 extracts the image processing job from the stored image processing jobs in the storage unit 402, the image processing job for which the user specified by the user specifying unit 403 has the authority of deletion or execution, based on the authority information acquired by the authority information acquiring unit 404. According to the embodiment of the present invention, the image processable job extracting unit 405 is included in the list creating unit 410. The processable job extracting unit 405 extracts the image processing job from the storage unit 402 based on the user ID inputted from the user specifying unit 403 and the authority information inputted from the authority information acquiring unit 404.

The processable job extracting unit 405 displays the extracted image processing jobs on the display 201 that is a display unit. According to the embodiment of the present invention, the processable job extracting unit 405 inputs the extracted image processing job to the operation recognizing unit 411, and the operation recognizing unit 411 displays it on the display 201.

The MFP further includes an unprocessable job extracting unit 406 and a notification unit 407. The unprocessable job extracting unit 406 extracts the image processing job for which the user specified by the user specifying unit 403 does not have the authority of deletion or execution from among the image processing jobs held in the storage unit 402, based on the authority information acquired by the authority information acquiring unit 404. According to the embodiment of the present invention, it is configured that the unprocessable job extracting unit 406 is included in the list creating unit 410. The unprocessable job extracting unit 406 extracts the image processing jobs to be processed from the storage unit 402 based on the user ID inputted from the user specifying unit 403 and the authority information inputted from the authority information acquiring unit 404.

Regarding the image processing jobs extracted by the unprocessable job extracting unit 406, the notification unit 407 notifies the user associated with the extracted image processing job of a request to delete or execute the extracted image processing job. The method of notification may employ any well-known method. It is not limited in particular, but it is configured in the embodiment of the present invention that the notification unit 407 has registered in advance a notification address list recording the user ID of the user listed in the authorized user list and a destination for the notification, like a mail address, associated with the user ID.

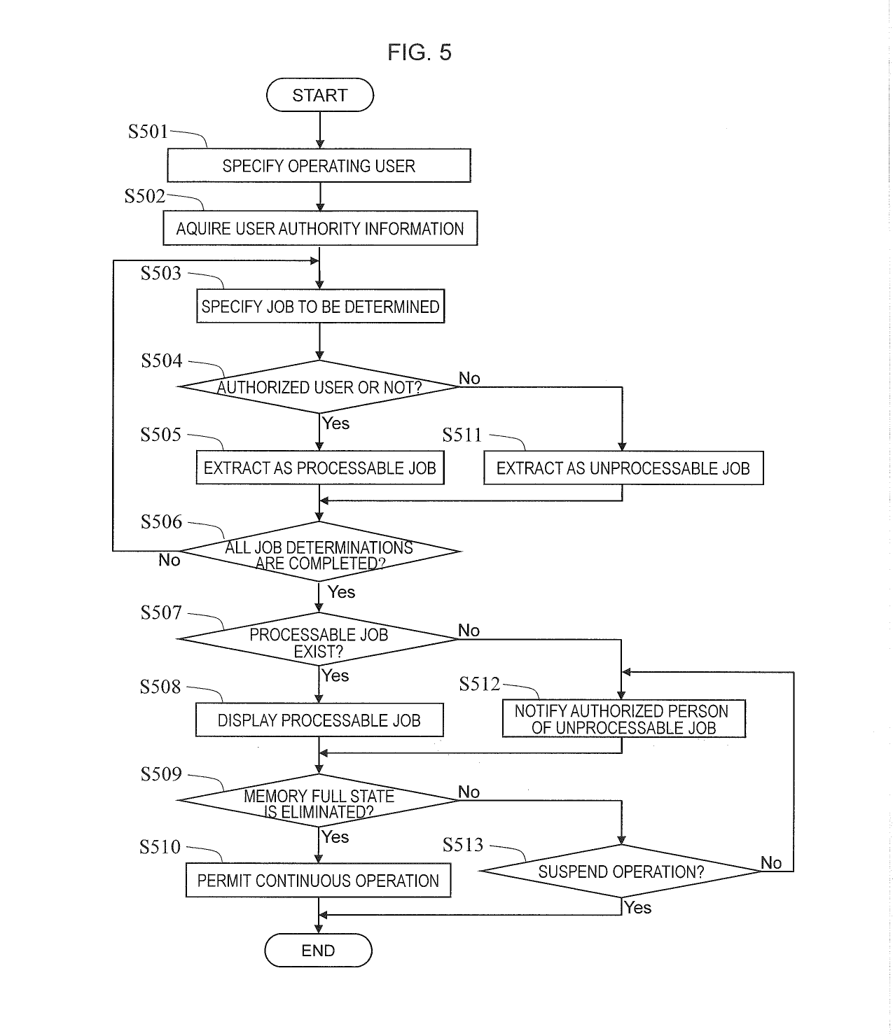

FIG. 5 is a flowchart showing an example of memory full state eliminating procedure executed by the MFP 100 according to the embodiment of the present invention. The procedure starts when the memory full state occurs. The embodiment of the present invention explains about the case where the memory full state occurs in the middle of creating the image data by the image reading unit 120 for copying plural sets of a bundle of original sheets (printed matters) by the user of the MFP 100.

When printed matters are obtained by copying the plural sets of original, the MFP 100 stores the image data of all the original sheets in the storage unit 402 as the print job. In the production process of the print job, for example, the image data of each original created by the image reading unit 120 is held temporarily in the RAM 302, and the image data on the RAM 302 is moved to the storage unit 402. Where the memory full state occurs in the middle of the production process of the print job, the job receiving unit 401 fails to move the image data to the storage unit 402. The job receiving unit 401 holds the failed image data on the RAM 302 and suspends the creation of the image data by the image reading unit 120 in a state capable to resume the creation.

When the memory full state occurs, the user specifying unit 403 specifies the operating user based on the user ID used by the user authentication unit 412 at the user authentication (Step S501).

The user specifying unit 403, that has specified the user, inputs information of the specified user (the user ID) to the list creating unit 410. At this time, the list creating unit 410 inputs the user ID to the authentication information acquiring unit 404, and instructs the authentication information acquiring unit 404 to acquire the authority information associated with the inputted user ID. Upon receipt of the instruction, the authority information acquiring unit 404 the authority information associated with the inputted user ID from the authority information list in the authority information management unit 408, and inputs the acquired authority information to the list creating unit 410 (Step S502).

The list creating unit 410 specifies one job from among the image processing jobs in the storage unit 402 as an object to be determined (Step S503). The order of specifying the image processing jobs is not limited in particular, but for instance, the jobs can be specified in order that the time of storing the image processing job is older.

The processable job extracting unit 405 of the list creating unit 410 determines whether or not the user ID associated with the image processing job specified as the object to be determined belongs to the authority in the authority information inputted from the authority information acquiring unit 404 (whether or not the operating user has the authority to process the job) (Step S504). For instance, when the authority information indicates “only the image processing job created by the user himself can be executed or deleted,” if the user ID associated with the image processing job to be determined is identical with the user ID inputted from the user specifying unit 403, the processable job extracting unit 405 determines the user ID belongs to the authority of the authority information. When the authority information indicates “only the image processing job created by a member of the user's group”, if the user ID associated with the image processing job to be determined belongs to the group including the user ID inputted from the user specifying unit 403, the processable job extracting unit 405 determines the user ID belongs to the authority of the authority information. Besides, the correspondence relation between the group and the user ID belonging to the group has been registered in advance in the list creating unit 410.

According to the embodiment of the present invention, the list creating unit 410 also includes the unprocessable job extracting unit 406 as described above. Therefore, the image processing job to be determined is determined by the unprocessable extracting job 406 at the same time of the determination by the processable job extracting unit 405. That is to say, the unprocessable job extracting unit 406 determines whether the user ID associated with the image processing job to be determined does not belong to the authority of the authority information inputted from the authority information acquiring unit 404.

When the user ID associated with the image processing job to be determined belongs to the authority of the authority information inputted from the authority information acquiring unit 404, the processable job extracting unit 405 extracts the image processing job as a processable job (Step S504 Yes, S505). Additionally, when the user ID associated with the image processing job to be determined does not belong to the authority of the authority information inputted from the authority information acquiring unit 404, the unprocessable job extracting unit 406 extracts the image processing job as an unprocessable job (Step S504 No, S511). These determinations are executed with respect to all the image processing jobs in the storage unit 402 (Step S506, No).

After completing all the determinations of the image processing jobs in the storage unit 402, the processable job extracting unit 405 confirms whether or not the extracted image processing exists (Step S506 Yes, S507). When the extracted image processing job exists, the processable job extracting unit 405 displays the extracted image processing job on the screen of the display 201 through the operation recognizing unit 411 (Step S507 Yes, S508).

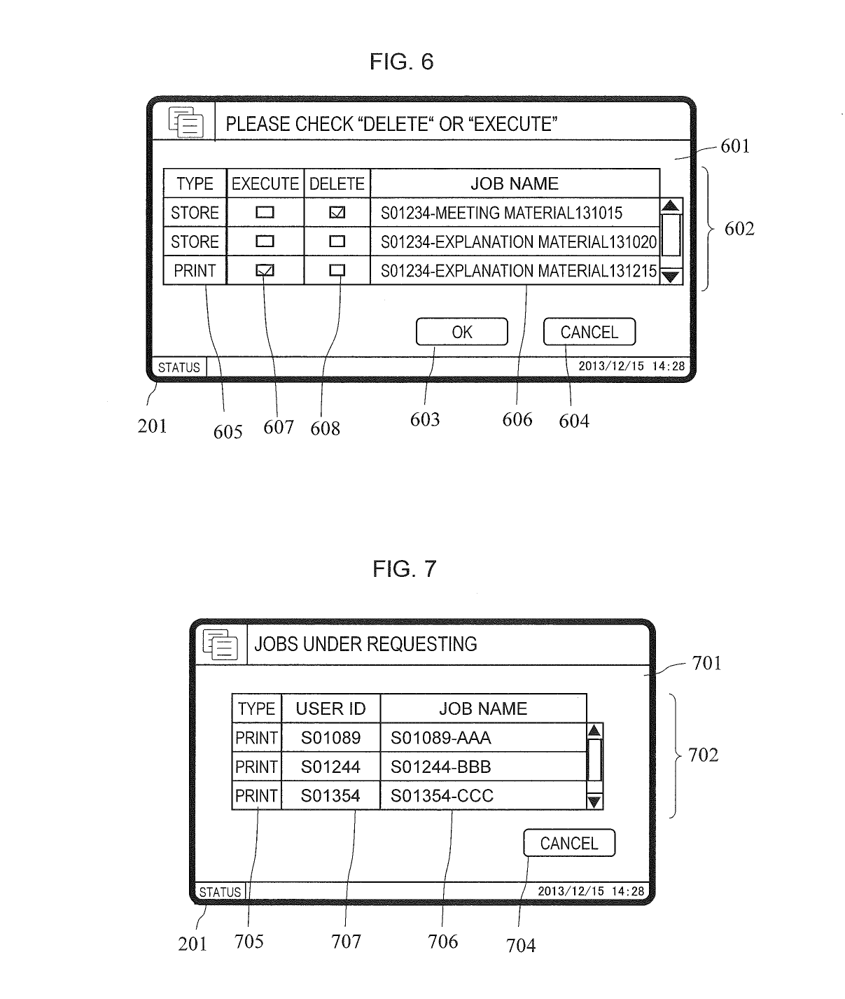

FIG. 6 is a diagram indicating an example of a processable job list displayed on the display 201 at this time. As shown in FIG. 6, a processable job list displaying screen 601 includes a processable job list displaying field 602, an “OK” button 603, and a “cancel” button 604.

The processable job list displaying field 602 displays the image processing jobs extracted by the processable job extracting unit 405. In the example, a job type displayed on a type field 605 and a job name (a combination of the user ID and a file name) displayed on a job name field 606 are used as the information to make the user recognize the image processing job. For instance, a “STORE” of the job type shown in FIG. 6 is a store job that the operating user stored the print job in the storage unit 402 in order to execute the printing later. A “PRINT” of the job type is the print job that the operating user inputted to the MFP 100 from the other device through the network interface 161.

The processable job list displaying field 602 also displays an execution check box 607 and a deletion check box 608 corresponding to each image processing job. The user can specify the image processing job as an object to be executed by checking the execution checkbox (ON state). The user can specify the image processing job as the object to be deleted by checking the deletion check box 608. The check boxes 605 and 606 are configured that the checked state (ON state) and the unchecked state (OFF state) are switched according to the user selection. It is not limited in particular, but when the use selects the “execute” of the STORE job or the PRINT job, the print job is executed immediately by the image forming unit 140 and the print job disappears.

The processable job list displaying screen 602 displays a scroll bar if necessary, whereby a display area can be moved. FIG. 6 shows a state that a vertical scroll bar is displayed.

On the other hand, when the processable image processing job does not exist as an extraction result of the processable job extracting unit, the processable extracting unit 405 notifies the unprocessable extracting unit 406 of the result (Step S507 Yes). Upon receipt of the notice, the unprocessable job extracting unit 406 makes the notification unit 407 inform the user corresponding to the extracted unprocessable image processing job of a request for deletion or execution of the image processing job (Step S512). As described above, the notification unit 407 transmits an e-mail describing contents of the request to the registered destination associated with the user, whereby the notification is executed.

According to the embodiment of the present invention, the MFP 100 is provided with a web displaying function. For instance, the CPU 301 executes a web server program read from the HDD 304, so that the MFP 100 can provide the other devices with a web service. Specifically, the other device like the information processing terminal can browse a web page offered by the MFP 100. The above-mentioned e-mail describes a URL (Uniform Resource Locator) of the web page for the user to select the processing of each image processing job extracted by the unprocessable job extracting unit 406. Upon receipt of the e-mail, the user can instruct the processing of the image processing job held in the storage unit 402 and associated with himself through the web page of the URL accessed by the user. For instance, it is possible to make the web page display same as the processable job list displaying screen 601 shown in FIG. 6.

FIG. 7 is a view indicating an example of a list of jobs under requesting displayed on the display 201 when the notification unit 407 transmits a request to the other user for deletion or execution of the image processing job. As shown in FIG. 7, the list of jobs under requesting 701 includes a list field 702 of jobs under requesting, and a “CANCEL” button 704.

The list filed 702 of jobs under requesting displays the image processing jobs that the notification unit 407 transmits the request for the processing. In this example, the job types and the job names are described in a job type field 705 and in a job name field 706 respectively as the information to make the user recognize the image processing job. In a user ID displaying field 707, the user ID associated with each image processing job is described.

When, in a state that the display 201 is displaying the processable job list displaying screen 601, the user checks either one of the check box 605 or 606, and selects the “OK” button 603, the job receiving unit 401 executes the processing of the image processing job corresponding to the checked check box 605 or 606 based on the checked state. In this case, a storage area of the storage unit 402 increases as much as the deleted or executed data volume of the image processing job. Likewise, when the other user received the e-mail instructs to execute or delete the image processing job that the other user has the authority, the job receiving unit 401 executes the selected image processing job based on the other user's instruction. In this case, the storage area of the storage unit 402 increases as much as the deleted or executed data volume of the image processing job. When such processing is executed, the memory full state is eliminated (Step S509 Yes). At this time, the job receiving unit 401 permits resuming the creation of the image processing job that was suspended because of the occurrence of the memory full state (Step S510). Besides, when the memory full state occurs after resuming the suspended creation of the image processing job, the procedure of eliminating the memory full state starts again.

In addition, in a state that the display 201 is displaying the processable job list displaying screen 601, the user selects the “CANCEL” button 604, so that the processable job list displaying screen 601 is closed without executing the processing for the image processing job displayed in the porocessable job list displaying field 602. As a result, the storage unit 402 does not increase the recordable area. Therefore, the memory full state cannot be eliminated (Step S509 No). In this case, the porocessable job extracting unit 405 notifies the unprocessable job extracting unit 406 that the memory full state is not eliminated. Upon receipt of the notice, the unprocessable job extracting unit 406 makes the notification unit 407 notify the user associated with the processing job extracted as the unprocessable job of the request to delete or execute the image processing job (Step S513 No S512).

When the user does not instruct to delete or execute the image processing job that the user has the authority, in response to the request from the notification unit 407, the storage unit 402 does not increase the recordable area. Accordingly, the memory full state is not eliminated (Step S509 No). In this case, the user selects the “CANCEL” button 704 of the list field of jobs under requesting 702 displayed on the display 201, if necessary. According to the user's instruction, the job receiving unit 401 cancels the image processing job creation that was suspended because of the occurrence of the memory full state (Step S513 Yes).

In the above-mentioned embodiment of the present invention, it is explained about the case where the memory full state occurs in the middle of operating the MFP 100 directly by the user. However, even when the memory full state occurs in the middle of the operation of the MFP though the network interface 161, the same effect can be obtained. In such case, the function of the display 201 on the operation panel 200 in the above embodiment can be provided with input means like display means and a keyboard included in the information processing terminal that is an external device. When the operation from the network interface 161 is the input of the print job from the other device, the data volume of the print job is notified to the MFP 100 at the beginning of the communication. If the storage unit 402 does not have enough capacity to store the print job, the memory full state occurs. In this case, the job receiving unit 401 makes the other device stand by (suspend) the transmission of the print job, and then when the storage unit 402 secures the capacity for storing the print job according to the above processing, the job receiving unit 401 makes the other device transmit the print job. Otherwise, when the storage unit cannot secure the capacity for storing the print job according to the above processing, the receiving unit 401 makes the other device stop the transmission of the print job.

According to the above embodiment of the present invention, it is configured that the processing request is automatically notified to the other user, but it may be configured to ask the operating user whether or not the request is transmitted before the execution of the notification. In addition, it may be configured that, before the execution of the notification, the users to be notified are displayed on the display and the operating user can select the destination of the processing request.

Moreover, according to the above embodiment of the present invention, it is described about the MFP that is provided with the HDD 304 as the storage unit 402, but the same effect can be provide with the memory full state that occurred in a semiconductor memory where the MFP is provided with the semiconductor memory like the RAM.

As described above, in the MFP 100, when the storage unit 402 is in the memory full state, the user operating the MFP 100 at that time can show the authorized user the image processing job processable to be deleted or executed by the authorized user. When the authorized user deletes or executes the displayed image processing job, the memory full state can be eliminated. That is to say, the user cannot delete or execute the image processing job that the user does not have the authority. Accordingly, it is possible to prevent that the other user without the authority delete or execute the image processing job unintentionally. And the user can easily recognize the image processing job that the user can delete or execute, so that the processing of the image processing job can be executed easily.

According to the MFP 100, even when the storage unit does not store the image processing job that the user operating the MPF 100 can delete or execute according to his authority, it is possible to request the other user to delete or execute the image processing job stored in the storage 402. As a result, it is possible to improve the user friendliness with respect to the image processing job stored in advance.

Besides the above described embodiment is not limited to the technical scope of the present invention, but except for the above embodiment, other variations and modifications may be made in accordance with the scope of the present invention. For instance, it is configured in the above embodiment that the processable job extracting unit 405 extracts the image processing job in the state of the memory full. But the processable job extracting unit 405 may be configured to extract the image processing job according to the instruction that the user inputted, even when it is not in the memory full state.

According to the embodiment of the present invention, the device is provided with the unprocessable job extracting unit 406 and the notification unit 407 as the preferable configuration, but these elements are not always necessary for the present invention. Even if the device is not provided with the unprocessable job extracting unit 406 and the notification unit 407, it is possible to eliminate the memory full state without sacrificing the security when the memory full state occurs. And it is possible to improve the user friendliness with respect to the image processing job stored in advance.

In the flowchart shown in FIG. 5, the order of each step can be changed appropriately in the scope of providing with the equivalent effect. For instance, it is configured in the flowchart in FIG. 5 that the extraction of the processable job and the extraction of the unprocessable job are performed in parallel, but the extraction of the unprocessable job may be executed when the processable job does not exist in the result of the extraction of the processable job.

In addition, according to the embodiment of the present invention, the present invention was materialized by the digital multifunction peripheral. The present invention can be applied not only to the digital multifunction peripheral but to any image processing device like the scanner, the printer, and the copying machine.

According to the embodiment described above, the present invention was configured that the MFP that is the image forming device includes all the elements, but it may be configured that the image processing system appropriately connects with each element formed individually through the network. For instance, it may be configured that the authority information management unit is separately formed from the MFP like the server device and the authority information acquiring unit acquires the authority information from the server device. In such image processing system, a plurality of the image processing devices can share the authority information management unit. In addition, as described above, it may be configured that the image processing unit connects the other device like the information processing terminal, and the other device is provided with the operation unit inputting the operation to the image processing device and the display unit displaying the image processing job extracted by the processable job extracting unit.

The present disciption describes the image processing system provided with an image processing device, an operation device, and an authority information management device. In such image processing system, the image processing device is provided with the job receiving unit, the storage unit, the user specifying unit, the authority information acquiring unit, and the processable job extracting unit. The operation device is provided with the operation unit and the display unit. The authority information management device is provided with the authority management unit.

The job receiving unit of the image processing device receives the image processing job. The storage unit holds the image processing job received by the job receiving unit. The user specifying unit specifies the user currently operating. The authority information acquiring unit acquires the authority information that the user specified by the user specifying unit has for the image processing job stored in the storage unit. The processable job extracting unit extracts the image processing job from the image processing jobs in the storage unit, the image processing job for which the user specified by the your specifying unit has the authority of deletion or execution, based on the authority information obtained by the authority information acquiring unit.

Furthermore, the operation unit of the operation device is used to input the operation to the image processing device. The display unit displays the image processing job extracted by the processable job extracting unit of the image processing device. The authority information management unit of the authority information management device manages the authority information acquired by the authority information acquiring unit of the image processing device.

### DESCRIPTION OF THE PREFERENCE NUMERAL

100 Multifunction Peripheral (Image forming device)

200 Operation panel

201 Display (Display unit)

401 Job receiving unit

402 Storage unit

403 User specifying unit

404 Authority information acquiring unit

405 Processable job extracting unit

406 Unprocessable job extracting unit

407 Notification unit

1. An image processing device comprising:
a job receiving unit that receives an image processing job including image data;
a storage unit that holds the image processing job received by the job receiving unit;
a user specifying unit that specifies a user currently operating;
an authority information acquiring unit that acquires authority information indicating authority that the user specified by the user specifying unit has with respect to the image processing job held in the storage unit;
a processable job extracting unit that extracts the image processing job from the image processing jobs in the storage unit, the image processing job for which the user specified by the your specifying unit has the authority of deletion or execution, based on the authority information obtained by the authority information acquiring unit;
an unprocessable job extracting unit that extracts the image processing job from the image processing jobs in the storage unit, the image processing job for which the user specified by the your specifying unit does not have the authority of deletion or execution, based on the authority information obtained by the authority information acquiring unit;
a display unit that displays the image processing job extracted by the processable job extracting unit; and
a notification unit that notifies a request to delete or execute the image processing job to an information processing terminal of the user associated with the image processing job extracted by the unprocessable job extracting unit,
wherein the job receiving unit receives the image processing job based on an instruction of the user from the display unit or the instruction from the information processing terminal of the user corresponding to the image processing job extracted by the unprocessable job extracting unit through the network interface.

2. The image processing device according to claim 1, wherein the processable job extracting unit extracts the image processing job when the storage unit becomes a memory full state.

3. (canceled)

4. The image processing device according to claim 1, wherein the unprocessable job extracting unit extracts the image processing job when the processable job extracting unit does not extract any image processing job.

5. The image processing device according to claim 1, wherein the extraction of the processable job extracting unit is performed in parallel with the extraction of the unprocessable job extracting unit.

6. The image processing device according to claim 1, wherein a destination to be notified of the request by the notification unit is selectable by the user.

7. An image processing system provided with an image processing device, an operation device, an authority information management device, the system comprising:
the image processing device has
a job receiving unit that receives an image processing job including image data;
a storage unit that holds the image processing job received by the job receiving unit;
a user specifying unit that specifies a user currently operating;
an authority information acquiring unit that acquires authority information indicating authority that the user specified by the user specifying unit has with respect to the image processing job held in the storage unit;
a processable job extracting unit that extracts the image processing job from the image processing jobs in the storage unit, the image processing job for which the user specified by the your specifying unit has the authority of deletion or execution, based on the authority information obtained by the authority information acquiring unit;
an unprocessable job extracting unit that extracts the image processing job from the image processing jobs in the storage unit, the image processing job for which the user specified by the your specifying unit does not have the authority of deletion or execution, based on the authority information obtained by the authority information acquiring unit; and
a notification unit that notifies a request to delete or execute the image processing job to an information processing terminal of the user associated with the image processing job extracted by the unprocessable job extracting unit;
the operation device has an operation unit that inputs an instruction to the image processing device; and
a display unit that displays the image processing job extracted by the processable job extracting unit; and
the authority information management device has
an authority information management unit that manages the authority information acquired by the authority information acquiring unit of the image processing device and being associated with the image processing job and the user,
wherein the job receiving unit receives the image processing job based on an instruction of the user from the display unit or the instruction from the information processing terminal of the user corresponding to the image processing job extracted by the unprocessable job extracting unit through the network interface.
